(19) United States
(12) Patent Application Publication
(10) Pub. No.: US 2016/0159146 A1
(43) Pub. Date: Jun. 9, 2016

(54) COMPACT CROSS LUG WRENCH WITH CENTER DRIVE

(71) Applicant: Margarito Ramirez, JR., Chicago, IL (US)

(72) Inventor: Margarito Ramirez, JR., Chicago, IL (US)

(21) Appl. No.: 14/962,723

(22) Filed: Dec. 8, 2015

Related U.S. Application Data
(60) Provisional application No. 62/088,784, filed on Dec. 8, 2014.

(51) Int. Cl. B60B 29/00; B25B 13/00; B25G 1/00

(52) U.S. Cl. CPC B60B 29/003; B25G 1/005; B25B 13/005

(57) ABSTRACT

A compact cross lug wrench with a center drive opening connectable to a drive post of a breaker bar. The breaker bar coupled to the compact cross wrench can apply a substantial force to loosen or tighten a lug nut on a motor vehicle. The drive post may be pivotally attached to the breaker bar.

### CROSS-REFERENCE TO RELATED APPLICATION

This application claims the benefit of priority of U.S. provisional application No. 62/088,784, filed Dec. 8, 2014, the contents of which are herein incorporated by reference.

### BACKGROUND OF THE INVENTION

The present invention relates to wrenches and, more particularly, to lug wrenches for removing and securing lug nuts on a motor vehicle.

Many have encountered the laborious and dreaded task of changing a tire with the inadequate tools provided with most passenger vehicles and light trucks. Some of the OEM supplied lug wrenches require extra parts that can be lost. Even more of the OEM lug wrenches in the art provide inadequate leverage for breaking loose the lug nuts, particularly where the vehicle has a high torque specification for the lug nuts.

Alternatives to OEM supplied lug wrenches are well known, but have their own detractors. For example there are many after-market cross lug wrenches. These are a vast improvement over the OEM wrenches, however they are still limited in the torque that may be developed by the user's operation of the crossed arms of the wrench. In addition, they can be relatively large and there may be inadequate stowage compartments for containing the wrench while not in use.

Another alternative is the use of power tools. While these are ideally suited for scheduled maintenance activities, they are generally unavailable to the user for a roadside emergency condition, such as changing a flat tire. Moreover, they are an expensive proposition, particularly for those who only need an adequate tool for a road side emergency condition.

As can be seen, there is a need for a lug nut removal tool that is readily stored or stowed, permits the user to develop substantial torque, and does not require substantial training for the user to use.

### SUMMARY OF THE INVENTION

In one aspect of the present invention, a lug wrench comprises: a cross wrench comprising a hub portion with a plurality of socketed arms extending radially therefrom, a drive slot defined in the hub portion, the drive slot opening substantially perpendicular to the socketed arms; and an elongate bar comprising a first end and a second end and a drive attachment post extending from the first end, the drive attachment post operable with the drive slot opening to connect the elongate bar with the cross wrench. The socketed arm may further comprise a sized socket end and the sized sockets ends may have different internal dimensions. In certain embodiments, the hub portion further comprises a plurality of radially defined bores adapted to receive an attachment end of the socketed arms. The attachment end may be welded within the bores or alternatively, may be coupled with cooperating threads.

In another aspect of the invention, the elongate bar may comprise a handle. The drive attachment post is pivotally attached to the first end of the elongate bar and the drive attachment post may be substantially square shaped. In some embodiments, the drive attachment post further includes a pawl.

Yet another aspect of the invention includes a cross lug wrench, comprising: a hub portion, a plurality of socketed arms radially disposed about the hub, a drive slot defined in a central portion of the hub, the drive slot opening substantially perpendicular to the socketed arms; and a sized socket defined at an end of the socketed arms opposite the hub portion. The sized socket may be defined with a different internal dimension on the socketed arm. In a preferred embodiment, the cross lug wrench of claim may include at least four socketed arms. The socketed arms may be threadingly coupled to the hub portion or are welded to the hub portion.

A method of removing a lug nut is disclosed and claimed in yet another aspect of the invention. The method comprises: providing a lug wrench, comprising: 1) a cross wrench having a hub portion with a socketed arm extending radially therefrom, a sized socket defined at a distal end of the socketed arm, and a drive slot defined in the hub portion, the drive slot opening substantially perpendicular to the socketed arm; and 2) an elongate bar having a first end and a second end and a drive attachment post extending from the first end, where the drive attachment post is operable with the drive slot opening to connect the elongate bar with the cross wrench; coupling the cross wrench to the elongate bar; coupling the sized socket to a lug nut; applying a force to the elongate bar to rotate the lug nut.

The method may further comprise uncoupling the cross wrench from the elongate bar. Other aspects of the method include rotating the cross wrench to rotate the lug nut, which may include rotation of the lug nut in a tightening direction or rotation of the lug nut in a loosening direction.

These and other features, aspects and advantages of the present invention will become better understood with reference to the following drawings, description and claims.

### BRIEF DESCRIPTION OF THE DRAWINGS

FIG. 1: Is a perspective view of the invention shown in use

FIG. 2: Is a perspective view of the invention

FIG. 3: Is an exploded view

FIG. 4: Is a section view of the invention taken from 4-4 in FIG. 1 illustrated without the hand for clarity

FIG. 5: Is an enlarged section view

FIG. 6: Is a top view

FIG. 7: Is a side view illustrating the movement of 10

FIG. 8: Is a bottom view

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a center drive compact cross lug wrench, operable with a breaker bar. The wrench of the present invention is

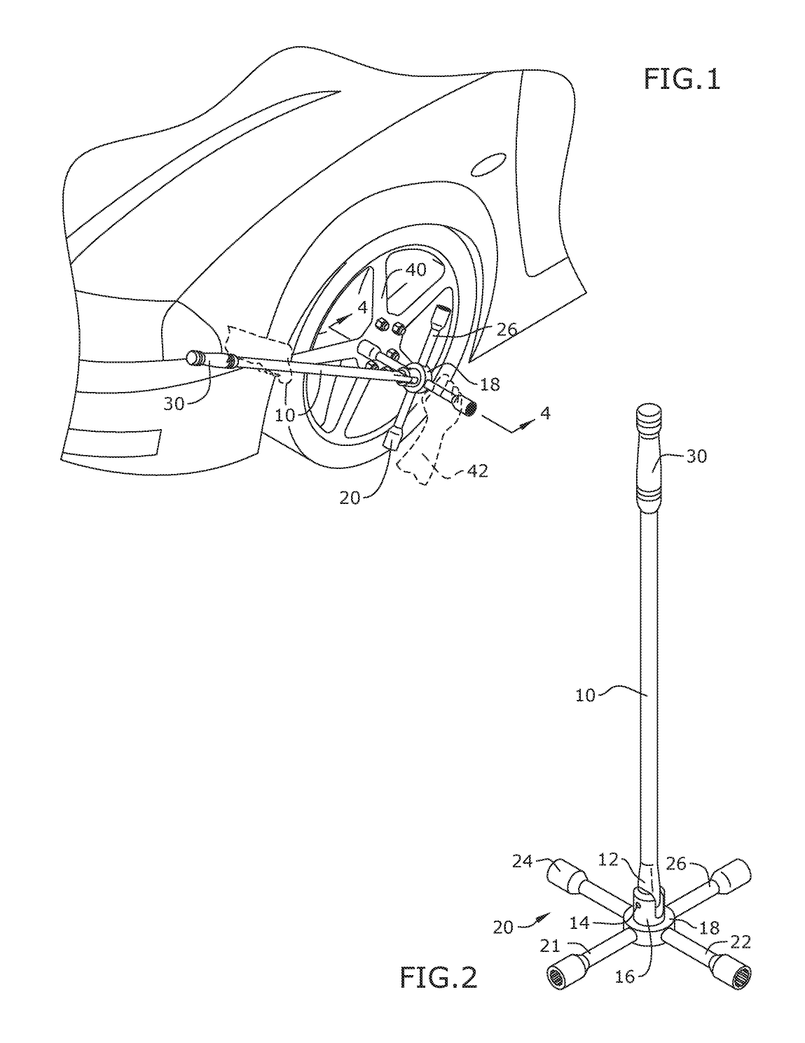

As best seen in reference to FIGS. 1-3, the compact center drive cross lug wrench and breaker bar of the present invention is shown in use to remove a lug nut from the wheel 40 of a motor vehicle. The wrench of the present invention may comprise an elongate breaker bar 10 and a compact cross lug wrench 20. The breaker bar 10 is attachable to a center hub 18 of the compact cross lug wrench 20. The breaker bar 10 may be a conventional breaker bar known in the art, having an elongate shaft with a handle 30 disposed at a first end and a pivoting joint 12 at a second end. In a preferred embodiment, a drive attachment post 16 is attached to the breaker bar 10 via a pivot pin 14. Alternatively, the breaker bar 10 of the present invention may be formed with a fixed drive attachment post 16 disposed at the second end of the breaker bar 10.

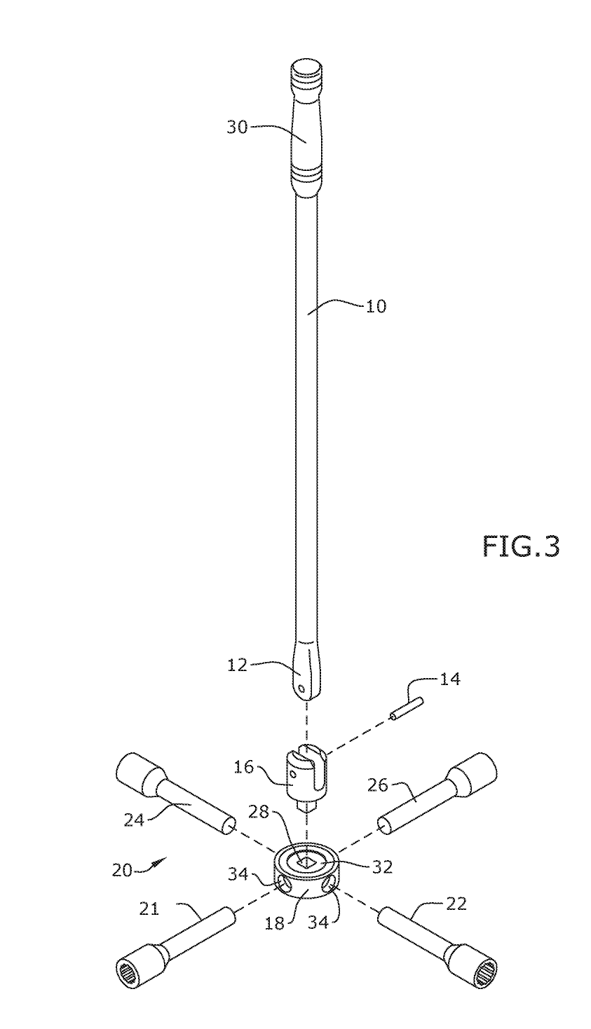

As best seen in reference to FIGS. 3-8, the compact cross lug wrench 20, comprises a central hub portion 18 adapted to receive a plurality of socketed lug arms 21, 22, 24, and 26 radially disposed from the central hub portion 18. The central hub portion 18 further comprises a drive slot 28, which is adapted to receive the drive attachment post 16 of the breaker bar 10 therein. In a preferred embodiment, the hub portion 18 may comprise a recessed area 32 defined in a face of the hub 18 about the drive slot 28, which is adapted to receive a cylindrical portion of the drive attachment post 16. In a preferred embodiment, the drive attachment post 16 and drive slot 28 are square shaped, as with a conventional socket type wrench and breaker bar. More preferably, the drive slot 28 and drive attachment post are a ½ inch square drive, but may also be a 1″, ¾″, or ⅜ inch drive, depending upon the size and torque that may need to be applied to the lug nut. The drive attachment post 16 may further comprise a pawl or retractable ball protrusion to assist in retaining the breaker bar 10 in the drive slot 28.

The socketed lug arms 21, 22, 24, and 26 have a shaft at a first end that is received within a bore 34 defined in the central hub portion 18. In some embodiments the first ends are welded to the hub portion 18. In other embodiments, the first ends may be threaded, to be received in a threaded bore 38 if the central hub 18. The threads may further include left and right hand thread combinations so that the socketed lug arms 21, 22, 24, and 26 may be removable, yet operable to tighten and loosen a lug nut. Since the cross wrench of the present invention may have strong a rotational force applied to the sized socket via the hub portion 18 and the breaker bar 10, the length of the socketed lug arms 21, 22, 23, 24 may be substantially shorter than those of a conventional cross wrench, thereby saving space in a stowage compartment.

A sized socket is defined at a second end of the lug arms 21, 22, 25, and 26 and may be defined with a plurality of differently sized sockets so as to be adaptable to a plurality of differently sized vehicle lug nuts. The sized sockets may also be formed to SAE or Metric dimensions. Alternatively, the sockets may be defined for a specified size corresponding to the lug nuts of a particular vehicle.

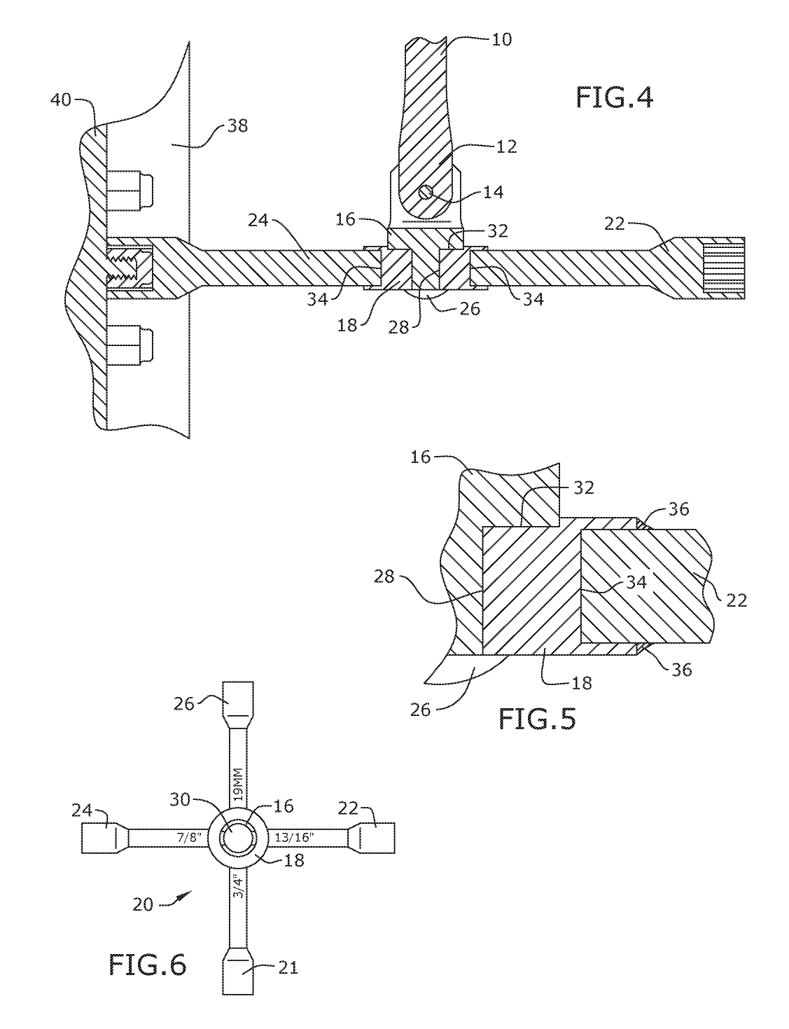

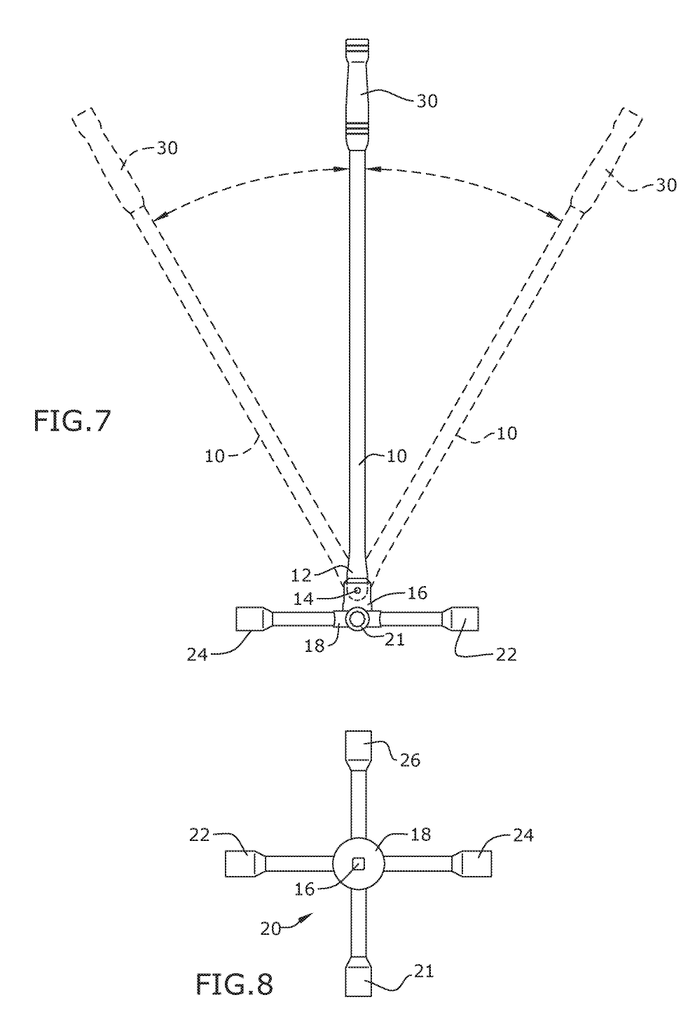

To use the lug wrench of the present invention, the user would couple the breaker bar 10 to the cross wrench 20 via the attachment post 16 with slot opening 28. Preferably, the breaker bar 10 is attached to the cross wrench 20 so that the pivoting movement about the pin 14, illustrated in reference to FIGS. 4 and 7, is aligned with the axis of the socketed lug arm, such as 24 that is sized to correspond with the vehicle lug nut. The user may then couple the selected sized socket of the lug arm to the vehicle lug nut. The user may then apply a force to the breaker bar 10 so as to turn the lug nut in the desired loosening direction, depending upon the thread pattern of the lug nut. Preferably, the user may grasp the handle 30 to apply the force. Should the user desire additional stability in applying the force, the user may grasp an opposite lug arm with the user's other hand. Once the applied force has broken loose the torqued lug nut, the user may continue to apply force to the breaker bar 10 and continue to loosen the lug nut. Preferably, the user will remove the breaker bar 10 from the cross wrench 20, which then permits the user to rotate the cross wrench 20 and remove the lug nut.

Should the vehicle lug nuts be recessed within the fender well of the vehicle, the breaker bar 10 may be pivoted about the pivot pin 14 so as to provide a lateral clearance from the car body. The user may then apply force to the breaker bar 10, as described above.

It should be understood, of course, that the foregoing relates to exemplary embodiments of the invention and that modifications may be made without departing from the spirit and scope of the invention as set forth in the following claims.

What is claimed is:

1. A lug wrench comprising:
a cross wrench comprising a hub portion with a plurality of socketed arms extending radially therefrom, a drive slot defined in the hub portion, the drive slot opening substantially perpendicular to the socketed arms; and
an elongate bar comprising a first end and a second end and a drive attachment post extending from the first end, the drive attachment post operable with the drive slot opening to connect the elongate bar with the cross wrench.

2. The lug wrench of claim 1, wherein the socketed arms further comprises a sized socket end.

3. The lug wrench of claim 2, wherein the sized sockets are of different internal dimensions.

4. The lug wrench of claim 1, wherein the hub portion further comprises, a plurality of radially defined bores adapted to receive an attachment end of the socketed arms.

5. The lug wrench of claim 4, wherein the attachment end is welded within the bores.

6. The lug wrench of claim 4, wherein the bores and the attachment end are coupled with cooperating threads.

7. The lug wrench of claim 1, wherein the second end of the elongate bar comprises a handle.

8. The lug wrench of claim 1, wherein the drive attachment post is pivotally attached to the first end.

9. The lug wrench of claim 1, wherein the drive attachment post is substantially square shaped.

10. The lug wrench of claim 1, wherein the drive attachment post further comprises a pawl.

11. A cross lug wrench, comprising:
a hub portion,
a plurality of socketed arms radially disposed about the hub,
a drive slot defined in a central portion of the hub, the drive slot opening substantially perpendicular to the socketed arms; and
a sized socket defined at an end of the socketed arms opposite the hub portion.

12. The cross lug wrench of claim 11, wherein the sized socket is defined with a different internal dimension on socketed arm.

13. The cross lug wrench of claim 11, further comprising:
at least four socketed arms.

14. The cross lug wrench of claim 11, wherein the socketed arms are threadingly coupled to the hub portion.

15. The cross lug wrench of claim 11, wherein the socketed arms are welded to the hub portion.

16. A method of removing a lug nut comprising:
providing a lug wrench, comprising:
a cross wrench comprising a hub portion with a socketed arm extending radially therefrom, a sized socket defined at a distal end of the socketed arm, and a drive slot defined in the hub portion, the drive slot opening substantially perpendicular to the socketed arm;
an elongate bar comprising a first end and a second end and a drive attachment post extending from the first end, the drive attachment post operable with the drive slot opening to connect the elongate bar with the cross wrench;
coupling the cross wrench to the elongate bar;
coupling the sized socket to a lug nut;
applying a force to the elongate bar to rotate the lug nut.

17. The method of claim 16, further comprising:
uncoupling the cross wrench from the elongate bar.

18. The method of claim 17, further comprising:
rotating the cross wrench to rotate the lug nut.

19. The method of claim 16, wherein the lug nut is rotated in a tightening direction.

20. The method of claim 16, wherein the lug nut is rotated in a loosening direction.
